(19) United States
(12) Patent Application Publication
(10) Pub. No.: US 2004/0261665 A1
(43) Pub. Date: Dec. 30, 2004

(54) Adding Rice Flour to Portland Cement/Concrete to increase strength and durability.

(75) Inventor: Alan S Williamson, Lambertville, NJ (US)

Correspondence Address: ALAN WILLIAMSON, 38 PERRY ROAD, LAMBERTVILLE, NJ, 08530, US

(73) Assignee: Alan Scot Williamson, Lambertville, NJ (US)

(21) Appl. No.: 10/604,187

(22) Filed: Jun. 30, 2003

(51) Int. Cl. C04B 14/00; C04B 24/00

(52) U.S. Cl. 106/730

(57) ABSTRACT

The Discovery Channel did a documentary type show about “The Great Wall of China”. Researchers discovered that the stone in the wall had been deteriorating, but the mortar holding the stone together was not. They discovered that the mystery element in the mortar was Rice Flour.

### DETAILED DESCRIPTION

Add Rice Flour to the paste mic og Portland Cement. The amount to be added is determined by the level of durability

1. Rice Flour increases the strength and durability of Portland Cement
